(19) United States
(12) Patent Application Publication
(10) Pub. No.: US 2010/0131585 A1
(43) Pub. Date: May 27, 2010

(54) DISPLAYING INFORMATION IN A CLIENT/SERVER SYSTEM

(76) Inventors: Daniel Rodrigue, Ottawa (CA); Robert Desbiens, Ottawa (CA); Rami Abou-Nassif, Ottawa (CA)

Correspondence Address: EDELL, SHAPIRO, & FINNAN, LLC, 1901 RESEARCH BOULEVARD, SUITE 400, ROCKVILLE, MD, 20850, US

(21) Appl. No.: 12/275,765

(22) Filed: Nov. 21, 2008

(51) Int. Cl. G06F 15/16

(52) U.S. Cl. 709/203; 709/231

(57) ABSTRACT

A client/server system for displaying information is described. The server includes a fragment server for providing a plurality of fragment objects to one or more clients, each fragment object including a markup component and a management component. The client includes a display for displaying a plurality of views, each view described by a markup component of a fragment object, and a fragment controller associated with said display for managing said plurality of fragment objects, said fragment controller receiving fragment objects from said server and updating a view of the plurality of views based on a markup component of the received fragment and updating one or more management components of the fragment objects based on the management component of the received fragment object.

### BACKGROUND

The present invention relates to displaying information, and more specifically to a client/server framework for displaying information on the client.

Portals are often used by corporations or organizations to provide a single point of access to a collection of services or programs. Portals may construct a view that amalgamates the different services or programs and displays them to a user. Portal pages are often accessed through a web browser running on an end user's computer. The end user points the web browser to a Universal Resource Locator (URL) of the portal to view the user interface (UI) provided by the portal.

The portal may construct the UI as an Hypertext Markup Language (HTML) file that displays information from the services or programs. The HTML of the UI may include links that the end user can click on, causing requests to be sent to the portal. The portal may receive the requests and direct them to the appropriate service or program for processing. The processing of the requests may result in new information being generated for display at the client. The portal may construct a UI page to display the new information and send the page to the client for display.

It can require a substantial amount of programming to create a portal that can generate UIs for information received from different sources, such as the services or programs. One attempt to address the problem of developing UIs to display information in portals has used standards to provide a frame work for requesting and receiving UI elements, which can be embedded in the portal UI. The UI elements typically include fragments of HTML code that can be inserted into an HTML document to provide the UI to the client of the end user. The first of the two standards are Web Services for Remote Portlets (WSRP) which describes how to request and transmit parts of HTML in Simple Object Access Protocol (SOAP) messages. The second standard is JSR-168 which is a standard that describes a portlet interface. Both WSRP and JSR-168 are incorporated herein by reference in their entireties. The portlets are run in a portal framework and can provide the UI elements as parts of HTML that can be transmitted using WSRP. The use of WSRP/JSR-168 can be used to provide a portal that includes a plurality of portlets providing UI elements for inclusion in a UI that is sent to the client.

Although the use of WSRP/JSR-168 aids in simplifying UI development for portals, its use can be cumbersome as a result of the web service interface of WSRP Furthermore, much of the processing of the UI is performed on the server, which can result in problems with the scalability of solutions built on WSRP/JSR-168 technology.

### SUMMARY

According to one embodiment of the present invention, there is provided a client/server system for displaying information. The system comprises a server having a processor for executing instructions stored in a computer readable memory coupled to said processor resulting in processor executed instructions, said processor executed instructions providing in said computer readable memory and a client having a client processor for executing instructions stored in a computer readable memory coupled to said client processor resulting in client processor executed instructions, said client processor executed instructions. The processor executed instructions of the server provides in said computer readable memory a fragment server for providing a plurality of fragment objects to one or more clients, each fragment object including a markup component and a management component. The client processor executed executed instructions on the client provides in said computer readable memory of the client a display for displaying a plurality of views, each view described by a markup component of a fragment object, and a fragment controller associated with said display for managing said plurality of fragment objects, said fragment controller receiving fragment objects from said server and updating a view of the plurality of views based on a markup component of the received fragment and updating one or more management components of the fragment objects based on the management component of the received fragment object.

According to another embodiment of the present invention, there is provided a method for streaming an XML document. The method includes creating an output steam writer for streaming the output of the XML document, creating an output buffer associated with the output stream writer for holding the information to write to the output stream writer, creating a default stream writer for writing available XML elements to the output buffer, determining an absence of an XML element required in the XML document and creating a marker for the XML element, replacing the marker in the output buffer when the XML element becomes available, determining that there is no more XML elements to write to the output stream, and closing the output stream writer.

### BRIEF DESCRIPTION OF THE SEVERAL VIEWS OF THE DRAWINGS

FIG. 1a depicts in a schematic, a network environment in which the embodiments of the present disclosure described herein can be practised;

FIG. 1b depicts in a block diagram, hardware components that may be used for the clients 106 and the server 104;

FIG. 2 depicts in a schematic an exemplary portal screen 200 displayed in a client's browser in accordance with the present disclosure;

FIG. 3 depicts in a block diagram, exemplary client-side components in accordance with the present disclosure;

FIG. 4 depicts in a block diagram an exemplary fragment in accordance with the present disclosure;

FIG. 5 depicts in a block diagram, exemplary components of the fragment controller in accordance with the present disclosure;

FIG. 6 depicts in a block diagram, exemplary components of a portal server in accordance with the present disclosure;

FIG. 7 depicts in a block diagram, exemplary components of a fragment server in accordance with the present disclosure;

FIG. 8 depicts in a flow diagram exemplary interactions of components of the display system in accordance with the present disclosure;

FIG. 9 depicts in a block diagram a merged XML document formed from separate XML elements in accordance with the present disclosure;

FIG. 10 depicts in a flow chart a method for streaming the XML document in accordance with the present disclosure;

FIG. 11 depicts a pseudo code listing, a corresponding output buffer representation and resultant output XML document in accordance with the present disclosure;

FIG. 12 depicts in a flow chart a method for providing transactional capabilities to an XML stream in accordance with the present disclosure; and

FIG. 13 depicts in a diagram, exemplary use cases and the resultant streamed output in accordance with the present disclosure.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, or store, the program for use by or in connection with the instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

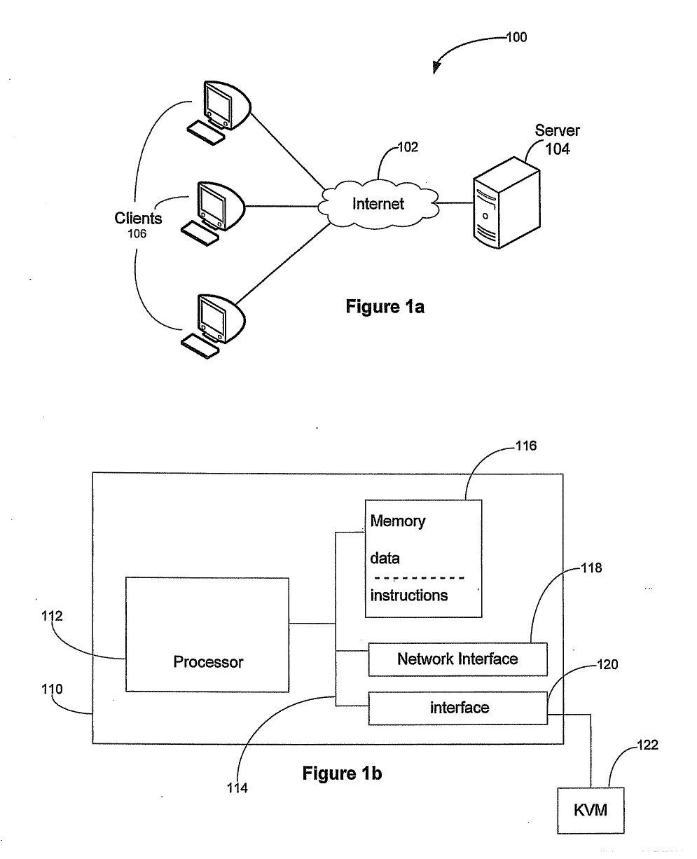

FIG. 1a depicts in a schematic, a network environment in which the inventions described herein can be practised. The environment 100 includes a plurality of clients 106. The clients 106 are coupled with a server 104 through a network 102 such as the Internet. Although the network is shown as the Internet, one of ordinary skill in the art will appreciate that other communication networks are possible, such as companies' local intranet. The clients 106 display information to an end user (not shown). End users can interact with the clients to control the information that is displayed. The clients 106 may receive the information to be display from the server 104. The client may communicate the end user's interactions to the server 104. The server 104 generates the information to be displayed by the different client 106. Although a single server is shown in FIG. 1a, one of ordinary skill in the art will appreciate that the function of the server may span multiple physical computers or servers.

The clients 106 may use a browser to display the information of the server 104. The server 104 may act as a portal that provides the browser of the client 104 with a single point of access for services and programs accessible to the server 104.

FIG. 1b depicts in a block diagram, hardware components that may be used for the clients 106 and the server 104. The hardware 110 comprises a processor 112 that is capable of executing instructions. The processor 112 is operatively coupled to computer readable memory 116. The computer readable memory may store both data information as well as instructions that are executed by the processor 112. The processor 112 and memory 116 may be operatively coupled through a bus 114. A network interface 118 may also be operatively coupled to the processor through the bus 114. The network interface 118 couples the hardware 110 to the network 102. An input/output (I/O) interface 120 is also operatively coupled to the bus 114. The (I/O) interface 120 may connect to input and output devices such as a keyboard, video, mouse (KVM) 122. One of ordinary skill in the art will appreciate that a KVM 122 may not be required, or may be replaced with different means for inputting and outputting information.

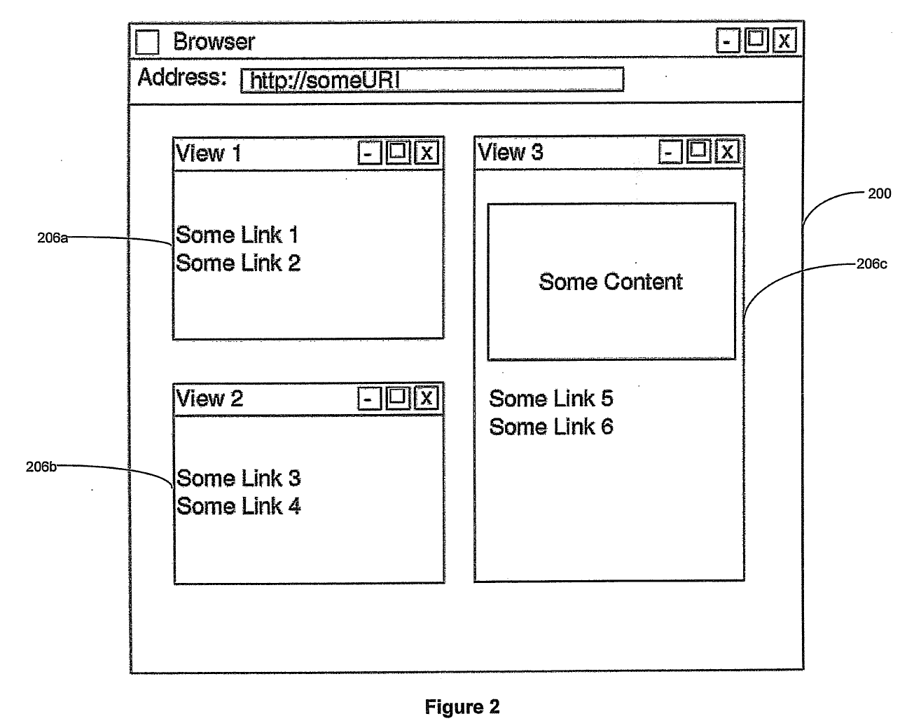

FIG. 2 depicts in a schematic an exemplary portal screen 200 displayed in a client's browser in accordance with the present disclosure. The screen 200 includes 3 different views 206a, 206b, 206c. Each of the views displays some information, depicted as links or content. Each of the views 206a, 206b, 206c may be described by markup that includes HTML and JavaScript code for providing interaction and control and may be formatted according to a Cascading Style Sheet (CSS). Each view, 206b, 206c can be inserted into a pagelet which describes the layout of the views.

As described further herein, a view is described by a markup component of a fragment object. The browser on the client may include a fragment controller that manages the views displayed in the pagelet. The client side fragment controller allows individual views to be updated without requiring the entire pagelet to be updated or reloaded. In addition to the markup component, the fragment object includes management components that may be used by the client-side fragment controller for managing the fragment objects that are associated with the pagelet being displayed.

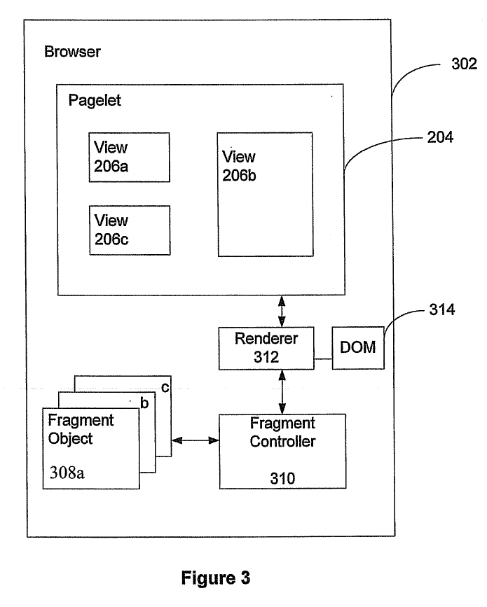

FIG. 3 depicts in a block diagram, exemplary client-side components in accordance with the present disclosure. A browser 302 is provided for displaying information on the client. As is commonly known in the art, a browser may include a rendering component or renderer 312 for rendering the content to a display. As depicted in FIG. 3, the rendering component or renderer 312 renders a pagelet 204, which includes various views 206a, 206b, 206c (collectively referred to as views 206). The information for rendering the pagelet is stored in a document object model (DOM) 314. The DOM can be manipulated to modify the rendered pagelet.

In addition to the rendering component 312 and the DOM 314, the browser 302 includes fragment objects 308a, 308b, 308c (collectively referred to as fragment objects 308) that have been loaded into memory. The fragment objects 308 reference the markup describing the views 306 which is stored in the DOM. The browser 302 further includes a fragment controller 310 for managing the views 206 of the pagelet 204. The fragment controller 310 also manages the fragment objects 308 as described further herein. The fragment controller 310 may manage the views by interacting with the DOM to modify nodes of the DOM that include the views currently displayed. The application programming interface (API) for manipulating a browser's DOM is well known in the art.

An end user may direct the browser 302 to a portal running on a server. The portal provides the pagelet 204 to the browser 302. The initial pagelet 204 includes references to fragment objects 308 in a layout. The layout may be, for example an HTML table with <div> tags, where each <div> tag references a fragment object 308. The pagelet may also include the code for the fragment controller 310. When the browser 302 receives the pagelet, it loads the fragment controller 310. With the fragment controller 310 loaded in the browser 302, the fragment objects 308 referenced in the pagelet 204 are retrieved from the server. The fragment controller 310 processes the received fragments and manipulates the browser's DOM 314 to display the views 206 in the layout of the pagelet 204. Alternatively, as an optimization to reduce the amount of calls between the fragment controller and the server, the initial view of each fragment may be retrieved by the fragment server. Subsequent interactions with the views and fragment objects may be performed by the fragment controller.

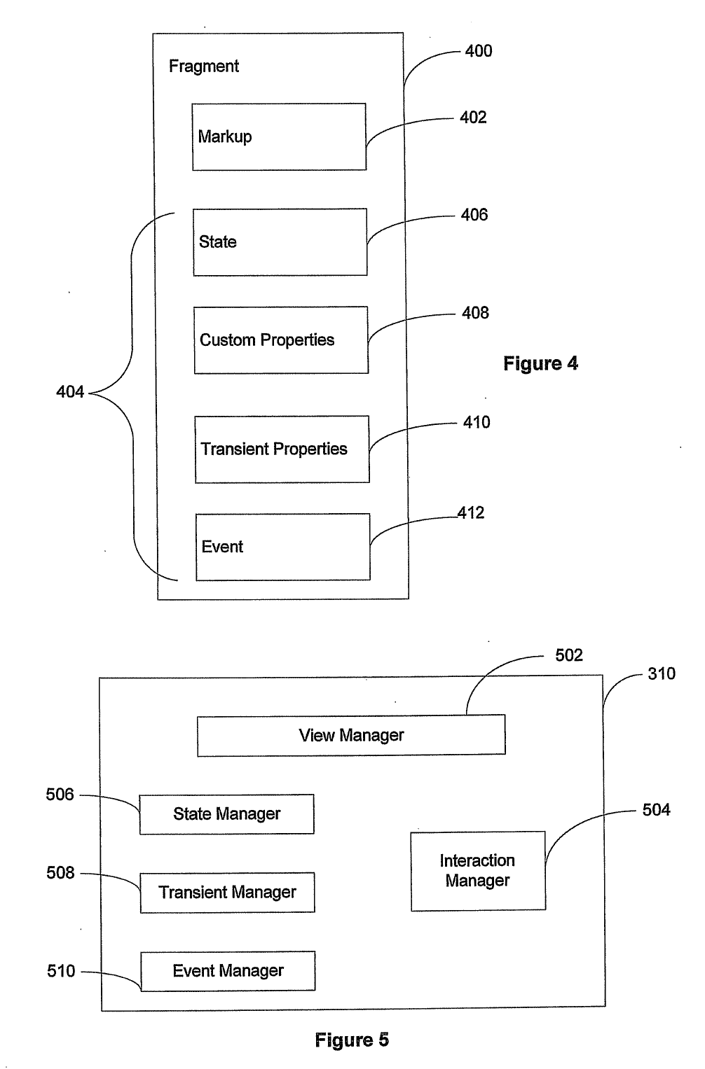

FIG. 4 depicts in a block diagram an exemplary fragment 400. Fragments are addressable XML documents that represent an embeddable UI component. The fragments contain views created with markup (HTML, JavaScript and/or CSS). The fragments also contain metadata about the fragment properties and capabilities. Fragments may be directly inlined when rendering a page or delayed until the client page activates, for example by an on Load event to ensure that all of the components required by the fragment are present on the client. Fragments are managed in the client by a fragment controller 310. The fragment controller 310 may be provided to the client browser with the pagelet as a set of JavaScript code. Alternatively it may be included as a component of the browser. The fragment controller 310 may be built on an asynchronous JavaScript and XML (AJAX) asynchronous HTML and HTTP (AHAH) engine. Fragments 400 are represented in the client by a JavaScript fragment object 308, which maintains all of the information required to communicate with a fragment producer via the fragment server running on the server 104. The fragment objects 308 may expose customization properties which can be encoded into the base URI used to address the fragment producer. Fragment objects 308 can communicate with each other via the fragment controller 310 using a type of shared state called transient properties, and events.

The fragment 400 is an extensible markup language (XML) document that is used by the fragment controller 310 to load a corresponding fragment object 308. A fragment 400 corresponds to a fragment object 308. As depicted in FIG. 4, a fragment 400 (and so a corresponding fragment object 308) includes a markup component 402, state component 406, custom properties component 408, transient properties component 410 and an event component 412. The state component 406, custom properties component 408, transient properties component 410, and event component 412 provide information used by the fragment controller 310 to manage the fragment objects. Not all of the components (406, 408, 410, 412) are required to be present in a fragment 400. The components 406, 408, 410, 412 may collectively be referred to as a management component 404. The management component 404 includes information for the fragment controller 310 to use in managing the fragment objects 308. The components 402, 406, 408, 410, 412 are XML child elements of the fragment root node element.

The markup component 402 includes tags describing the markup of the view associated with the fragment. The markup of the view may include HTML code, and JavaScript code. The markup may include cascading style sheet (CSS) information for formatting the HTML code. The view information is stored in an XML element, for example a <markupstring>. The following is a schema for a markup component of a fragment 400.

```
<fragment>
  <meta>
    <markupTypes>xsd:string</markupTypes>
    <locales>xsd:string</locales>
    <modes>xsd:qname</modes>
    <windowStates>xsd:qname</windowStates>
  </meta>
  <preferredTitle>xsd:string</preferredTitle>
  <newMode>xsd:string</newMode>
  <newWindowState>xsd:string</newWindowState>
  <delay>xsd:int</delay>
  <markup id=“xsd:string” mode=“xsd:qname”
windowState=“xsd:qname”>
    <useCacheMarkup>xsd:boolean</useCacheMarkup>
    <mimeType>xsd:string</mimeType>
    <markupString>xsd:string</markupString>
    <markupXml>
      <xsd:any/>
    </markupXml>
    <markupBinary>xsd:base64</markupBinary>
    <cacheControl>
      <expires>xsd:int</expires>
      <validateTag>xsd:string</validateTag>
    </cacheControl>
    <validator>
      <param name=“xsd:nmtoken”>
        <validate>
          <type>xsd:string</type>
          <restrict>
            <min>xsd:int</min>
            <max>xsd:int</max>
            <contains>xsd:string</contains>
            <regex>xsd:string</regex>
          </restrict>
        </validate>
      </param>
    </validator>
  </markup>
</fragment>
```

Elements of the markup component 402 of the fragment may include:
a meta element that includes:
   a meta/modes element that describe the supported modes by the fragment producer. Modes are view, preview, edit, help and privates modes.
   a meta/windowStates element that describe the supported window states by the fragment producer. Window states are normal, minimized, maximized and private window states.
   a redirectURL element that indicate a new location or server-side redirection.
a newWindowState element that indicate a window state change by the fragment producer (e.g. going from a normal to a maximized window state).
a newMode element that indicate a mode change by the fragment producer (e.g. going from an edit to a view mode).
a delay element that indicate the fragment controller to refresh the current view in the specified number of seconds.
a markup element includes:
a markup/@id property that uniquely identify the markup
   a markup/useCacheMarkup element that indicate that the consumer has the latest markup in its cache and no markup is actually returned.
   a markup/mimeType element that indicate the format of the markup (e.g. text/html)
   a markup/markupString element that contains the actual markup, like the html and javascript tags and text.
   a markup/markupXml element that contains the actual markup, as XHTML.
   a markup/markupBinary element that contains the actual markup, as encoded base64 binary blob.
   a markup/cacheControl element that includes:
      a cacheControl/expires element that indicate when the markup would expire allowing the consumer/controller to keep the markup until that time.
      a cacheControl/validateTag element that indicate a control validation tag that the consumer/controller can provide back in order to let the producer evaluate if the cached markup is now obsolete or not.
   markup/validator element that includes:
      validator/param element that includes:
         a param/@name property that define the validator rules for the specific parameter name.
         a param/validate element that describes the rules of the validation.

In addition to the markup component element, a fragment 400 may include a state element 406 that includes information regarding the current state of the view of the fragment. The state should include all of the information necessary for the fragment producer to recreate the current view. In an exemplary embodiment of a fragment the state information is stored as a Base 64 blob. It is possible that the state element store the state information in a different form.

The fragment 400 may also include a custom property element 408. Custom properties of a fragment may provide control for the customization of the fragment 400. The fragment 400 declares custom properties using meta/customProperties elements, which contain information for enumerating, editing and validating the properties and their values. The actual customization of the properties is held in a fragment/custom element which may have one parameter element per custom property. Custom properties may be overridden by a fragment reference or a page/fragmentInstance. Custom properties are encoded as query-values in the base URI request for a fragment. In a secure environment, customizations, which may be encoded in the base URI, are encrypted to prevent tampering. The following listing is a schema highlighting the custom properties elements of a fragment.

```
<fragment>
  <meta>
    <customProperties name=“xsd:nmtoken”>
      <title xml:lang=“xsd:string”
resourceID=“xsd:nmtoken”>xsd:string</title>
      <hint xml:lang=“en”
resourceID=“xsd:nmtoken”>xsd:string</hint>
      <default>
        <value>xsd:string</value>
        <enum name=“one”
resourceID=“xsd:nmtoken”>xsd:string</enum>
      </default>
      <validate>
        <type>xsd:string</type>
        <restrict>
          <min>xsd:int</min>
          <max>xsd:int</max>
          <contains>xsd:string</contains>
          <regex>xsd:string</regex>
        </restrict>
      </validate>
    </customProperties>
  </meta>
  <custom>
    <param name=“xsd:nmtoken”>xsd:string</param>
    <param name=“xsd:nmtoken”>
      <any_xml_doc>
        <... >
      </any_xml_doc>
    </param>
  </custom>
</fragment>
```

In addition to the custom properties, a fragment 400 may also include a transient properties component 410. The transient properties are a form of scoped shared state that can be shared between fragment objects 308. The scope of transient properties may be either page or application. The page scope distributes transient property updates to the siblings and descendents of the fragment. Since fragments may include other fragments as subfragment, the distribution of updates to siblings and descendants allow the fragment to control how the sub-fragment will behave in the page. The following listing is schema highlighting a transient property elements of a fragment.

```
<fragment>
  <meta>
    <transientProperties name=“xsd:nmtoken”>
      <title xml:lang=“xsd:string”
resourceID=“xsd:nmtoken”>xsd:string</title>
      <hint xml:lang=“xsd:string”
resourceID=“xsd:nmtoken”>xsd:string</hint>
      <scope>xsd:string</scope>
      <default>
        <value>xsd:string</value>
        <enum name=“one” xml:lang=“xsd:string”
resourceID=“xsd:nmtoken”>xsd:string</enum>
      </default>
      <validate>
        <type>xsd:string</type>
        <restrict>
          <min>xsd:int</min>
          <max>xsd:int</max>
          <contains>xsd:string</contains>
          <regex>xsd:string</regex>
        </restrict>
      </validate>
    </transientProperties>
  </meta>
  <transientUpdate
name=“xsd:nmtoken”>xsd:string</transientUpdate>
</fragment>
```

Transient properties 410 allow for inter fragment co-ordination. If more information is required to be exchanged between fragments, it can be done through an event frame work. Fragments 400 may include an event component 412. The event component 412 may register an event listener of the fragment object with the fragment controller 310. When the corresponding event is raised a message is passed to the registered event listener of the fragment object. In addition to registering event listeners with the fragment controller 310, the event component 412 may also describe the events that the fragment (or more particularly, the fragment object) can raise. When a fragment object raises an event, an associated payload is passed to the appropriate event listeners of other fragment objects 308. One skilled in the art will appreciate that the message may be passed to the appropriate event listeners in various ways, for example, as described above a fragment may define an event listener or handler for a specific event that is called when the specific event is raised. Alternatively, the fragment controller 310 may pass the raised event to the fragment objects 308 which determine whether to process the event or not. A schema of the event component is shown in the following listing.

```
<fragment>
  <meta>
  ...
    <publishedEvents>event.name</publishedEvents>0..*
    <handledEvents>event.name</handledEvents>0..*
    <eventDescriptions name=“event.name” type=“xsd:QName”>0..*
      <aliases>0..*
        xsd:string
      </aliases>
      <description xml:lang=“” resourceName=“”>
        xsd:string
      </description>
      <label xml:lang=“” resourceName=“”>
        xsd:string
      </label>
      <hint xml:lang=“” resourceName=“”>
        xsd:string
      </hint>
      <extensions>0..*
        xsd:any
      </extensions>
    </eventDescriptions>
    </meta>
  ...
  <event name=“event.name” type=“xsd:QName”>0..*
    <payload>
      <params>0..*
        <param name=“xsd:NMToken”>xsd:string</param>
      <params>
      xsd:any
    </payload>
    <extensions>0..*
      xsd:any
    </extensions>
  </event>
</fragment>
```

FIG. 5 depicts in a block diagram, exemplary components of the fragment controller 310. The fragment controller 310 includes a view manager 502 that manages the views that are displayed in the pagelet. When a fragment object is updated, the view manager 502 manipulates the browser DOM 314 to replace the current view of the associated fragment object 308 with the updated view. This allows individual views of the pagelet 204 to be updated without requiring the entire page to be reloaded. In addition to the view manager 502, the fragment controller 310 further includes an interaction manager 504 which manages the end user's interactions with the views. An end user may interact with the views, for example by clicking links or activating JavaScript functions of the fragment objects. The JavaScript may pass requests to the fragment controller 310, or more particularly the interaction manager 504, which can send a request for an updated fragment to the server and receive an updated fragment in return. The request for a fragment comprises a URI to a service that can produce fragments, referred to as a fragment producer. The fragment producer may support two types of URIs. The first type is a renderURI, which will refresh the fragment, including its view based on the current state, the custom properties and the transient properties information, which is encoded in the URI. The second type is a interactionURI, which is a renderURI with additional parameters. An exemplary URI syntax is:

[gateway]/fragment[pathInfo]?[frag-
*]&[custom]&[transient]&[params]

where:
gateway is the current gateway
/fragment invokes the fragment dispatcher handler to dispatch the fragment to the appropriate fragment producer
pathInfo is used by the fragment server to reference a cm object which also control users' access
frag-* are parameters used by the fragment controller to communicate with the fragment server, or fragment producer
custom parameters carry the customizations values for the fragment
transient parameters are those visible to the fragment based on the declared transient properties
params are application specific parameters originating from a form or link

The fragment controller 310 manages the states of all of the fragment objects 308. The state of a fragment object may change based on end user interactions with the view of the fragment object 308. The state may also be changed when the fragment object is updated with a new fragment or markup component. Additionally the state may be changed as a result of transient properties and events of other fragments as well as the end users interactions with them. The fragment controller 310 includes a state manager 504 for managing the state of all of the fragment objects 308. The fragment controller 310 also includes a transient manager 508 for managing the transient properties of all of the fragment objects 308. The transient manager 508 passes updated transient properties to any fragment objects 308 that have transient properties with the same name. The fragment controller 310 further includes an event manager 510 for managing the event of all of the fragment objects 308. Fragment objects 308 can raise events using the event manager 510, which then distributes the event to the appropriate fragment objects 308.

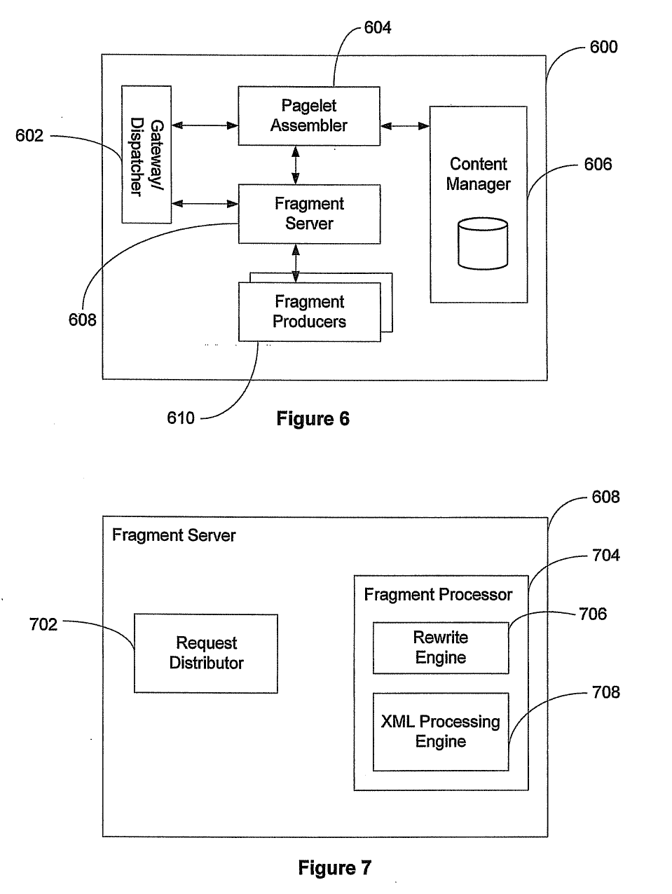

FIG. 6 depicts in a block diagram, exemplary components of a portal server 600 for providing pagelets and fragments to the fragment controller 310. The portal server 600 components may be implemented on the hardware described with reference to FIG. 1b. The server includes a gateway/dispatcher 602 for receiving requests and dispatching the received request to the appropriate location. The server further includes a pagelet assembler 604 for constructing a pagelet, which includes layout and fragments, which is returned to the client. The server further includes a fragment server 608 that produces a fragment 400 for returning to the client. The fragment server 608 may receive a fragment document from a fragment producer 610. The fragment server 608 then rewrites the markup and the fragment to create a fragment to be sent to the fragment controller, or optionally the pagelet assembler. The rewriting of the fragment document is done to avoid possible collisions between variable names or namespaces with other fragments on the client. The rewriting may qualify the variables or namespaces with a fragment identifier. The server may further include a content manager database 506 that stores information pertaining to all of the fragment producers 610 available on the server. The pagelet assembler 604 may use the content manager 510 to determine available fragment producers that can be used to construct the initial portal page to provide access to the fragment producers 610.

The server may further include a plurality of fragment producers 610 that produce the fragment documents. The fragment producers 610 may construct the fragment documents based on information received from the fragment controller 310 which may be encoded into the request URI.

FIG. 7 depicts in a block diagram, exemplary components of a fragment server 608. The fragment server 608 comprises a request distributor 702 that receives the URI from the fragment controller 310 and maps it to a resource, for example a fragment producer 610, and retrieves the resource, which is generally a fragment or fragment document. The fragment server further includes a fragment processor 704 for processing fragment documents. The fragment processor 704 includes a rewrite engine 706 for rewriting the fragment and an XML processing engine 708 for processing the XML of fragments or fragment documents. For example, if a fragment includes another fragment as a subfragment, the XML processing engine 708 may merge the two fragments together as required.

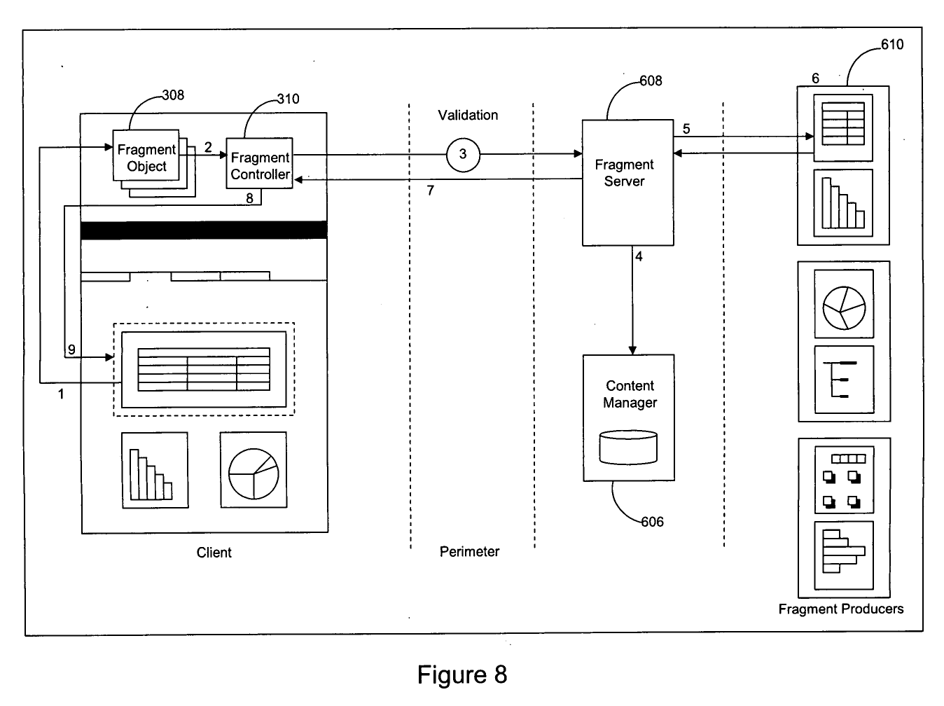

FIG. 8 depicts in a flow diagram exemplary interactions of components of the display system in accordance with the present disclosure. In the description of the interaction it is assumed that the server has already passed a pagelet including fragments to the browser, and that the browser has the fragment controller loaded. (1) An end user interacts with the fragment markup of the view and activates a link which has been rewritten to activate the JavaScript fragment object associated with the view and pass in the interaction parameters. (2) The fragment object constructs an interaction URI which includes the interaction parameters and calls the fragment controller 310 to retrieve the fragment corresponding to the URI. The fragment controller 310 requests the URI from the server. (3) The gateway server may validate the URI to ensure that parameters of the URI fall within an appropriate range. The range may be specified in a validator element as specified above. (4) When no valid producer URI is included in the base URI the server retrieves the fragment object from the content manager, which may verify access permissions of the end user, and if the retrieved fragment contains a fragment producer reference, the producer URI is encoded and signed and included as a base URI of the fragment request. (5) If the fragment request URI contains a valid producer URI, the fragment producer is called. (6) The fragment producer receives query-values encoded in the URI and returns a new fragment. (7) The fragment server rewrites the fragment according to fragment controller parameters so that the client side fragment controller can use the fragment produced from the fragment. The fragment server then returns the fragment to the fragment controller. (8) The fragment controller receives the fragment and updates the fragment object, which may include the re-distribution of transient property updates or events. (9) Fragment controller then updates the displayed pagelet with new markup from the fragment.

The use of fragments to provide embeddable UI elements to the client allows fragments to be included within fragments as subfragments. The fragment server may be required to combine the subfragment into the parent fragment prior to returning the whole fragment to the client. The fragment server can process the fragments and subfragments as XML documents and merge multiple XML documents into a single XML document, which is returned as the fragment to the client.

The fragment server may need to merge multiple XML documents into a single document. In order to reduce the overhead necessary to complete the processing it is desirable to use an XML stream. However, it is difficult to use an XML stream to combine separate XML elements or sections together into an output stream in an order that differs from the order in which they are available.

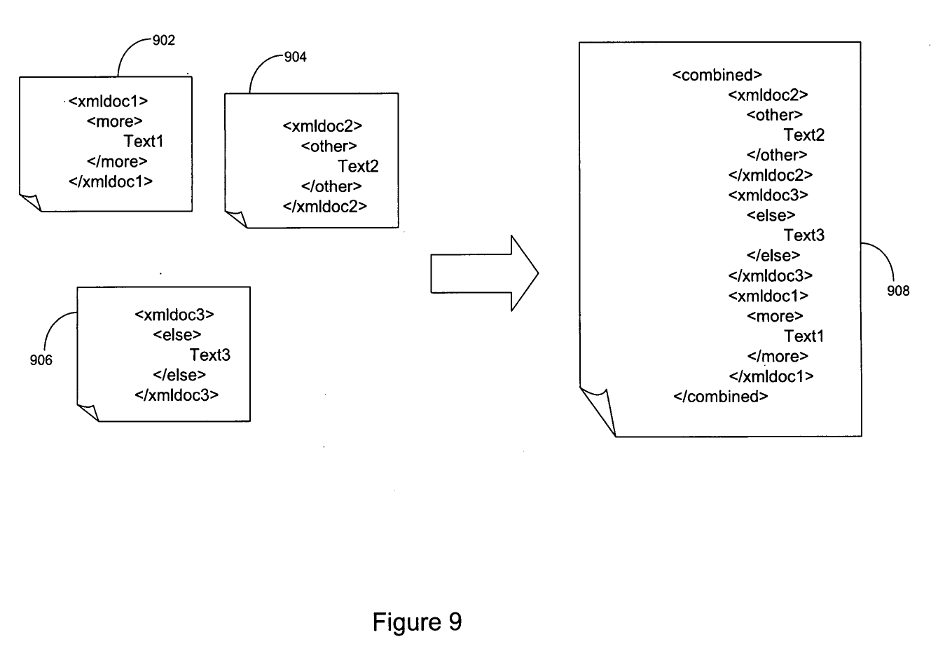

FIG. 9 depicts in a block diagram a merged XML document formed from separate XML elements. The XML elements 902, 904, 906 may be XML documents that already exist, or they may represent the output from a process or application that generates the XML elements as output. In FIG. 9, the merged output XML document 908 comprises some XML elements found in the merged output XML document, namely the <combined> and </combined> tag, which may be included in a merge template document. The merged XML document 908 also includes the XML of the three XML portions 902, 904, 906, which appear in the merged XML document in the order they were written to the output stream.

If all of the XML portions are available at the time the output stream is being written, all of the XML elements can be written to the output stream in the order required by the merged XML document. It is more complex to create the merged XML document using an output writing stream when not all of the XML elements 902, 904, 906 are available at the time of writing to the output steam.

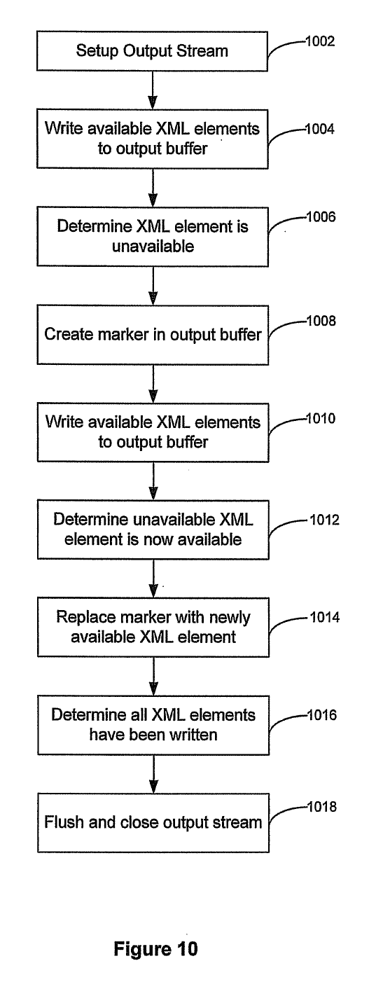

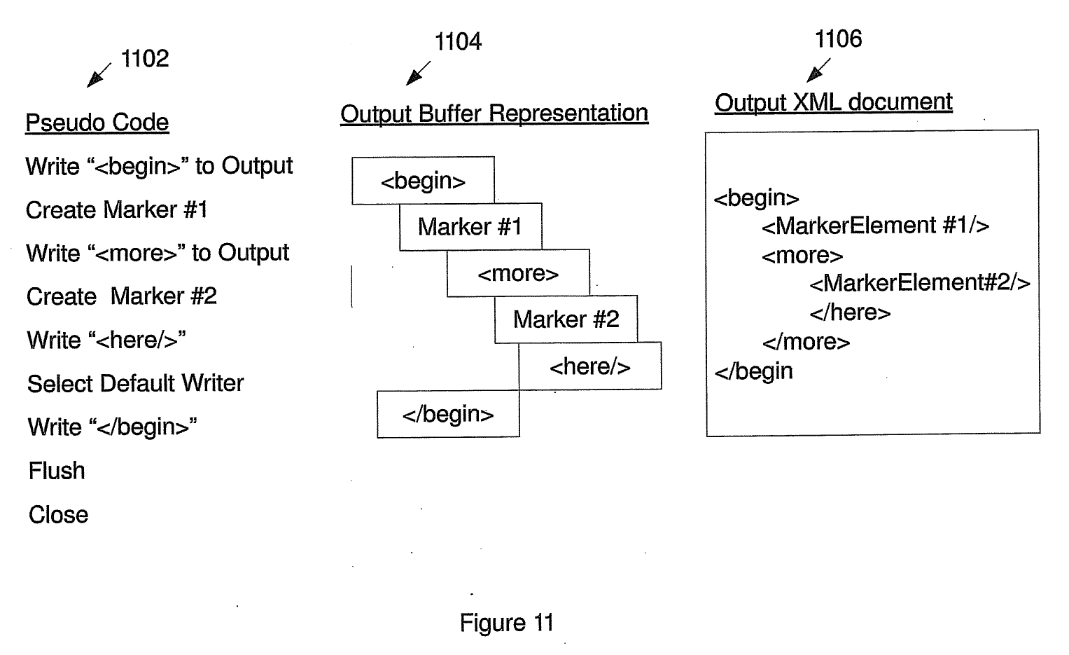

FIG. 10 depicts in a flow chart a method for streaming the XML document. The method comprises setting up the output stream (1002) for streaming the XML document. Setting up the output stream may include creating an output stream writer, an associated output buffer for buffering XML elements to the output stream writer, and a default stream writer for writing XML elements to the output buffer. The method writes available XML elements to the output buffer using the default stream writer (1004). The method determines that an XML element required to be inserted into the output stream is unavailable (1006). Instead of blocking until the XML element becomes available, the method creates a new marker in the output buffer (1008). Creating a marker may include creating a marker in the output buffer, creating a marker buffer associated with the marker for (eventually) holding the unavailable XML element and creating a marker stream writer for (eventually) writing the unavailable XML element to the marker buffer. Once the marker is created, the method continues writing available XML elements to the output buffer (1010). It should be appreciated that although only a single marker is described, multiple markers can be created for marking, and eventually writing, different XML elements to the output buffer as they become available. Also, it is possible to include markers within markers. The method continues when it is determined that the previously unavailable XML element is now available (1012). The method replaces the marker in the output buffer with the newly available XML element (1014). Replacing the marker may include selecting the marker stream writer and writing the newly available XML element to the marker buffer using the marker stream writer. Replacing the marker may further include replacing the marker in the output buffer with the newly written XML element in the marker buffer. The marker stream writer may be closed and the buffer space freed. With the marker replaced in the output buffer that method continues when it is determined that all of the XML elements have been written to the output stream (1016). The method may flush and close the output stream writer.

FIG. 11 depicts a pseudo code listing, a corresponding output buffer representation and resultant output XML document. As depicted in the pseudo code listing available XML elements are written to the output buffer. The available XML elements shown in the pseudo code listing is the <begin> tag. As can be seen from the corresponding buffer representation, the <begin> tag is written to the output buffer. Next a marker is created which crates a new marker writer that is used to write to the output buffer. Additional XML elements that are available are written to the buffer using the current stream writer (the marker writer), namely the <more> tag. A second marker is created, including creating a new stream writer for writing to the output buffer and the Marker #2 is written to the output buffer. The pseudo code then selects the default stream writer again, and writes the </begin> tag. The output stream writer is then flushed and closed. As can be seen the output XML document 1106, the markers in the output buffer are replaced with the XML elements once they have become available. Furthermore, the output stream writer ensures that the output XML document is well formed. In the example in FIG. 11, a </more> tag is added to the output XML by the output stream writer without the element being explicitly written to the output stream.

The XML processing engine may incorporate the above method for streaming a well formed XML document from different XML elements that may not all be available at the beginning of the output streaming. The streamer may include an external facing XMLStreamWriter (W) object that outputs the final XML document. When a new marker is created, a new XMLStreamWriter (Wₙ₊₁) and a new internal, or marker, buffer (Bₙ₊₁) is also created. Any existing namespace context is assigned to this new writer (Wₙ₊₁). Switching from one marker to another selects the right XMLStreamWriter and makes it the active one for writing to the output buffer associated with the external facing stream writer (W), or the output stream writer). New markers can be created anywhere at any time, whenever they are needed; however once a marker is created, it is not possible to write XML to the previous buffer. This ensures that the output XML document will be well formed. If needed, or desirable, the final output streaming may start as soon as contiguous buffers are known to be finished. These buffers can then be discarded afterward.

When merging XML components to form the output XML document, as described above, it may be required, or desirable to merge XML from various sources with a master XML document based on conditions that dictate whether the XML source must be included in the final result or not. The source that is to be excluded from the result should not be generated when possible for performance reasons. The conditions for merging sources may need to be validated against the current state of the merged document. As a result, the condition validation should take into account sources that have already been merged.

In order to provide a simple rules based method for generating the merged XML document, an XML source may be used. The XML source can be read using an XML reader, for example as provided by StAX, to read the XML document. The XML source streams the XML document as the XML reader is reading it. As such it is possible to generate the XML document as it is being read. The XML source may include rules for merging the XML pieces together. The following is a pseudo code listing of a sample program for providing an XML reader for reading an XML document.

Create “merge” reader
Assign (master) document to reader
Set rule for source1 (add after <a>)
Set rule for source2 (add under <text1>)
Set rule for source3 (add after <d>)
Set rule for source4 (add under <source3> if <text3> does not
exist)
Return “merge” reader

As can be seen from the above pseudo code listing a new XML reader is created for the merged document. With the merge reader created, the master document that the XML sources are to be merged with is assigned to the reader. The sources are then merged into the document by setting the rules under which the XML documents will be added. As a result, if a source does not meet the rule it is not included in the merged document, saving overhead and increasing performance. For example, source4 will be merged into the XML document, under <source3>, if <text3> does not exist. Assuming that <text3> does exist in the merged document, source4 will not be added. Since the rule is used, the XML processing engine does not need to read or process source4.

The XML processing engine may include modules for providing a rules-based XML merge reader as described above. The XML processing engine may also include a module to provide streaming re-ordering of XML elements. The rules-based XML merge reader may use streaming re-ordering to provide the merged XML document.

In addition to merging XML documents and re-ordering XML elements as described above, the XML processing engine can provide transactional writing of XML documents to an output stream. The transactional processing allows parts of an XML document to be placed in an output stream, and later removed from the output stream if necessary (rollback) or left (commit).

In the context of XML output streaming, the “transaction” starts when the output stream writer is positioned after a start element location. All subsequent API calls are considered as part of that unit. That unit of instructions can be either committed or rolled back. It is also possible to start a new transaction inside an existing unit of transaction. However, the committed inner unit is subject to the outer committed or rolled back transaction.

The transactional APIs may be added to the StAX APIs. The transactional StAX APIs include:
begin( ) is called indicate the start of a new XML stream writer transaction;
commit( ) is called to commit the current XML transaction to writer, or two a pending parent transaction if the committed transaction is nested; and
rollback( ) is called to remove the XML elements added to the stream writer during the current transaction.

The begin( ) must be called before commit( ) or rollback( ), and when the position in the output stream is after an opened start element. A begin( ) call can be invoked inside another started transaction; multi-levels of nested transactions. Each begin( ) call must eventually be balanced with either a commit( ) or rollback( ) call. Any number of nested transactions can be performed, however the memory consumption will increase as the number of nested transactions increases. After a commit( ) or a rollback( ) call, the XML is considered well-formed, and final output streaming can start as soon as level 1 transactions are committed, that is transactions that are not nested.

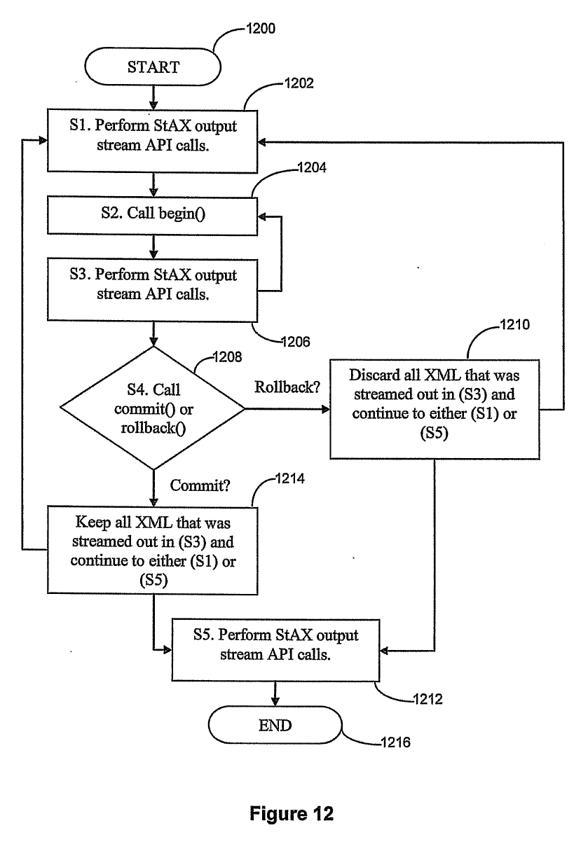

FIG. 12 depicts in a flow chart a method for providing transactional capabilities to an XML stream. The method starts 1200, StAX output stream API calls are performed (1202) to setup and begin the XML streaming. A begin( ) call is made (1204) to initiate the streaming XML transaction. Further StAX output stream API calls are made, for example writing elements to the stream (1206). If a transition is to be nested, the method returns to 1204 where another begin( ) is called to begin the nested transaction. Once the XML streaming transaction is complete, commit( ) or rollback( ) is called (1208). If rollback( ) has been called (Rollback? At 1208) then all XML that was streamed out in S3 (1206) is discarded and processing continues to S5 (1212) if there are no pending transactions and no further XML to be streamed. Otherwise the processing streams more XML at S1 (1202). At S5 (1212) StAX output stream API calls are performed in order to finish streaming the XML. If at S4 (1208) a commit( ) was called (Commit? At 1208) then all of the XML that was streamed out is maintained and processing returns to S1 if further XML elements exist, or to S5 if all of the XML has been processed.

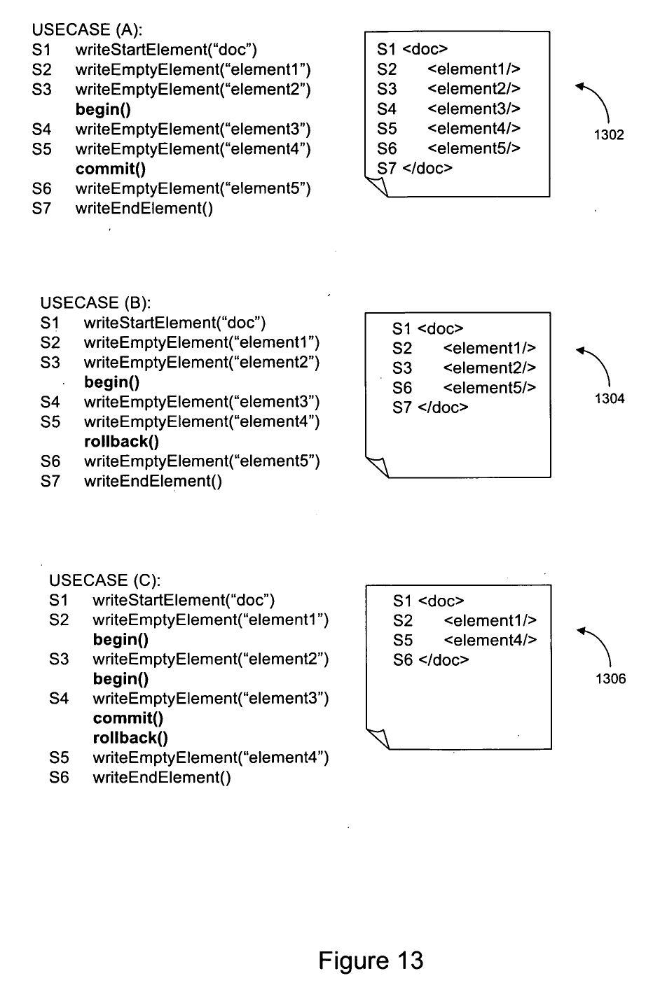

FIG. 13 depicts in a diagram, use exemplary cases and the resultant streamed output. Referring to use case A 1302, it can be seen that statements S4 and S5 are contained within a streaming XML transaction. Since the transaction was committed the elements written by S4 and S5 are in the output stream. Referring to use case B, 1304 the same statements are streamed, however in this case, the transaction has been rolled back and so the elements of S4 and S5 are not in the output stream. Referring to use case C, 1306 a nested transaction is shown. The inner transaction has been committed; however since the outer transaction has been rolled back, none of the elements streamed within the outer transaction are present in the output.

1-5. (canceled)

6. A method for displaying information comprising:
receiving one or more fragment objects at a first processing device each including a markup component and a management component, wherein said management component enables management of said fragment objects;
displaying a page including a plurality of views, wherein each view is described by said markup component of a corresponding received fragment object; and
updating a view on said displayed page based on said markup component of one or more of said received fragment objects corresponding to that view.

7. The method of claim 6, further including:
constructing and providing said one or more fragment objects from a second processing device to said first processing device, wherein said constructing includes:
receiving an identifier from said first processing device and mapping said identifier to a resource to retrieve a fragment object; and
processing said retrieved fragment object for conveyance to said first processing device.

8. The method of claim 7, wherein said fragment object includes one or more subfragments, and said processing said retrieved fragment object includes:
merging said fragment object and said subfragments to form said fragment object in the form of an XML document, and streaming the XML document for conveyance to said first processing device as said fragment object, wherein said streaming includes:
creating an output steam writer for streaming the output of the XML document;
creating an output buffer associated with the output stream writer for holding the information to write to the output stream writer;
creating a default stream writer for writing available XML elements to the output buffer;
determining an absence of an XML element required in the XML document and creating a marker for the XML element;
replacing the marker in the output buffer when the XML element becomes available;
determining that there are no more XML elements to write to the output stream; and
closing the output stream writer.

9. The method of claim 8, wherein creating the marker comprises:
writing a marker to the output buffer indicating the required position of the XML element in the XML document;
creating a marker buffer associated with the marker for holding the XML element once it is available; and
creating a marker stream writer associated with the marker buffer for writing the XML element to the marker buffer.

10. The method of claim 9, wherein replacing the marker in the output buffer comprises:
selecting the marker stream writer;
writing the XML element that is now available to the marker buffer using the selected marker stream writer;
replacing the marker in the output buffer with the marker buffer; and
closing the marker stream writer.

11. The method of claim 6, further including:
managing said one or more fragment objects and updating one or more management components of said fragment objects based on said management components of said received fragment objects.

12. The method of 11, wherein said management component comprises a state component, a custom property component, and a transient property component, and said managing includes:
managing a state of said one or more fragment objects according to said state component of said received fragment object, wherein said state component includes information pertaining to said state of a fragment object;
controlling customization of a fragment object according to said custom property component of that fragment object; and
managing transient properties of said one or more fragment objects to coordinate those fragment objects, wherein updated transient properties are passed to fragment objects including transient properties corresponding to said updated transient properties.

13. The method of claim 11, wherein said management component includes an event component, and said managing includes:
managing an event by distributing information to appropriate fragment objects in response to a fragment object raising said event.

14. The method of claim 6, wherein said updating said view includes:
manipulating a document object model (DOM) of a browser to replace a current view with an updated view.

15. The method of claim 6, wherein said displaying includes:
managing user interactions with said displayed views and requesting one or more updated fragment objects from said second processing device in response to said user interactions.

16. A system for displaying information comprising:
at least one storage system for storing at least one computer program; and
at least one processor for processing the at least one computer program to:
receive one or more fragment objects each including a markup component and a management component, wherein said management component enables management of said fragment objects;
display a page including a plurality of views, wherein each view is described by said markup component of a corresponding received fragment object; and
update a view on said displayed page based on said markup component of one or more of said received fragment objects corresponding to that view.

17. The system of claim 16, further including:
at least one other processor for processing at least one computer program to:
construct and provide said one or more fragment objects, wherein said constructing includes:
receiving an identifier and mapping said identifier to a resource to retrieve a fragment object; and
processing said retrieved fragment object.

18. The system of claim 17, wherein said fragment object includes one or more subfragments, and said processing said retrieved fragment object includes:
merging said fragment object and said subfragments to form said fragment object in the form of an XML document, and streaming the XML document for conveyance as said fragment object, wherein said streaming includes:
creating an output steam writer for streaming the output of the XML document;
creating an output buffer associated with the output stream writer for holding the information to write to the output stream writer;
creating a default stream writer for writing available XML elements to the output buffer;
determining an absence of an XML element required in the XML document and creating a marker for the XML element;
replacing the marker in the output buffer when the XML element becomes available;
determining that there are no more XML elements to write to the output stream; and
closing the output stream writer.

19. The system of claim 16, wherein said updating said view includes:
manipulating a document object model (DOM) of a browser to replace a current view with an updated view.

20. The system of 16, wherein said management component comprises a state component, a custom property component, a transient property component, and an event component, wherein said displaying includes:
managing user interactions with said displayed views and requesting one or more updated fragment objects in response to said user interactions; and
said at least one computer program is further processed to:
manage said one or more fragment objects and update one or more management components of said fragment objects based on said management components of said received fragment objects, wherein said managing said one or more fragment objects includes:
managing a state of said one or more fragment objects according to said state component of said received fragment object, wherein said state component includes information pertaining to said state of a fragment object;
controlling customization of a fragment object according to said custom property component of that fragment object;
managing transient properties of said one or more fragment objects to coordinate those fragment objects, wherein updated transient properties are passed to fragment objects including transient properties corresponding to said updated transient properties; and
managing an event by distributing information to appropriate fragment objects in response to a fragment object raising said event.

21. A computer program product for displaying information, the computer program product comprising:
a computer readable storage medium having computer readable program code embodied therewith, the computer readable program code comprising computer readable program code configured to:
receive one or more fragment objects each including a markup component and a management component, wherein said management component enables management of said fragment objects;
display a page including a plurality of views, wherein each view is described by said markup component of a corresponding received fragment object; and
update a view on said displayed page based on said markup component of one or more of said received fragment objects corresponding to that view.

22. The computer program product of claim 21, wherein said computer readable program code is further configured to:
construct and provide said one or more fragment objects, wherein said constructing includes:
receiving an identifier and mapping said identifier to a resource to retrieve a fragment object; and
processing said retrieved fragment object.

23. The computer program product of claim 22, wherein said fragment object includes one or more subfragments, and said processing said retrieved fragment object includes:
merging said fragment object and said subfragments to form said fragment object in the form of an XML document, and streaming the XML document for conveyance as said fragment object, wherein said streaming includes:
creating an output steam writer for streaming the output of the XML document;
creating an output buffer associated with the output stream writer for holding the information to write to the output stream writer;
creating a default stream writer for writing available XML elements to the output buffer;
determining an absence of an XML element required in the XML document and creating a marker for the XML element;
replacing the marker in the output buffer when the XML element becomes available;
determining that there are no more XML elements to write to the output stream; and
closing the output stream writer.

24. The computer program product of claim 21, wherein said updating said view includes:
manipulating a document object model (DOM) of a browser to replace a current view with an updated view.

25. The computer program product of claim 21, wherein said management component comprises a state component, a custom property component, a transient property component, and an event component, wherein said displaying includes:
managing user interactions with said displayed views and requesting one or more updated fragment objects in response to said user interactions; and
said computer readable program code is further configured to:
manage said one or more fragment objects and update one or more management components of said fragment objects based on said management components of said received fragment objects, wherein said managing said one or more fragment objects includes:
managing a state of said one or more fragment objects according to said state component of said received fragment object, wherein said state component includes information pertaining to said state of a fragment object;
controlling customization of a fragment object according to said custom property component of that fragment object;
managing transient properties of said one or more fragment objects to coordinate those fragment objects, wherein updated transient properties are passed to fragment objects including transient properties corresponding to said updated transient properties; and
managing an event by distributing information to appropriate fragment objects in response to a fragment object raising said event.
